(19) United States
(12) Patent Application Publication
(10) Pub. No.: US 2015/0135618 A1
(43) Pub. Date: May 21, 2015

(54) ENVIRONMENTALLY RESISTANT STRUCTURAL MEMBER

(71) Applicant: George S. Liu, Duluth, GA (US)

(72) Inventor: George S. Liu, Duluth, GA (US)

(21) Appl. No.: 14/408,898

(22) PCT Filed: Jun. 18, 2013
(86) PCT No.: PCT/US2013/046335

§ 371 Date: Dec. 17, 2014

Related U.S. Application Data
(60) Provisional application No. 61/660,993, filed on Jun. 18, 2012.

(51) Int. Cl. E04B 1/66; B29C 44/12; E04B 1/92; E04C 2/22; E04C 2/24

(52) U.S. Cl. CPC E04B 1/66; E04C 2/22; E04C 2/243; E04B 1/92; B29C 44/1266; B29C 44/1209; B29K 2075/00
USPC 52/309.1; 264/46.4

(57) ABSTRACT

Implementations of the present disclosure provide an environmentally resistant structural member for use in areas exposed to water or other environmental elements. The structural member includes a core member and a polymer layer. The core member has an environmentally sensitive composition wherein extended exposure to the environmental element causes degradation of the core member. The core member includes at least one surface, such as a bottom and side surfaces. The surface is configured for positioning in the area exposed to the environmental element. The polymer layer has a molded shape and covers the surface so as to seal the surface of the core member against exposure to the environmental element.

### CROSS REFERENCE TO RELATED APPLICATIONS

The present invention claims the benefit of U.S. Provisional Patent Application No. 61/660,993 filed Jun. 18, 2012, and is herein incorporated in its entirety by reference.

### BACKGROUND

A typical exterior doorframe is made from wood. For any frames that will be primed, the wood is typically made from pine due to lower costs. Non-primed, natural frames are made from the species required for their natural stained finish like Oak, Maple, Cherry or Pine.

The problem with wood frames, especially primed frames, is they are subject to rot and defection from the weather and termite elements. In many incidences the frames are rotted on the bottom due to the water wicking up from the unprotected bottom. Wood frame bottoms may also be subject to rot from termites. The rest of the frame is also subject to defects due to weather. Because wood is fiber based, the harshness of the weather can cause decay, deformation, and other defects.

Improvements to wood frames to fight moisture, rot and decay are therefore desired.

### SUMMARY

Implementations of the present disclosure overcome the problems of the prior art by providing an environmentally resistant structural member for use in areas exposed to water or other environmental elements. The structural member includes a core member and a polymer layer. The core member has an environmentally sensitive composition wherein extended exposure to the environmental element causes degradation of the core member. The core member includes at least one surface. The surface is configured for positioning in the area exposed to the environmental element. The polymer layer has a molded shape and covers the surface so as to seal the surface of the core member against exposure to the environmental element.

The core member may have a water permeable surface. For example, the core member may have a plurality of fibers, such as cellulose fibers. The core member may be a wood member, such as a low cost pine wood member.

Included in the molded shape of the core member may be a molded surface texture. For example, a wood grain pattern may be molded on the molded shape. Wood grain patterns may include oak, maple, cherry or pine.

The structural member may be configured for external use on a building. For example, it may be used as a frame member, such as a door or window frame member.

The polymer layer may be molded about an entire external surface of the core member. The polymer layer may have a thickness of ⅝ inch or less. For example, the polymer layer may be 3/16 of an inch. The polymer layer may include a polyurethane.

A method of molding the structural member includes placing a core member in a mould cavity. The mould cavity defines an external shape. The method includes placing one or more polymer components in the mould cavity. The mould cavity is sealed. The method also includes foaming the polymer components to encapsulate at least a portion of the core member. This generates an external layer of the structural member that is resistant to water permeation.

Foaming may include encapsulating the entire core member. Foaming the polymer components may also include combining at least two polyurethane components.

The core member may have a permeable surface. Foaming may include penetrating the permeable surface of the core member. For example, foaming the polymer components may include penetrating the fibers of the core member.

The method may also include forming a surface texture on the external layer.

Also, the method may include sizing the core member to have a gap between the edges of the mold and the core member of ⅝ inch or less.

The method may also include curing the external layer.

These and other features and advantages of the implementations of the present disclosure will become more readily apparent to those skilled in the art upon consideration of the following detailed description and accompanying drawings, which describe both the preferred and alternative implementations of the present disclosure.

### BRIEF DESCRIPTION OF THE DRAWINGS

FIG. 1 is a bottom view of an environmentally resistant structural member implemented as a door jamb;

FIG. 2 is a plan view of the door jamb of FIG. 1;

FIG. 3 is a cross-sectional view of the door jamb of FIG. 1;

FIG. 4 is a cross-sectional view of the door jamb of FIG. 1;

FIG. 5 is a perspective view of the door jamb of FIG. 1; and

FIG. 6 is a perspective view of removal of an environmentally resistant crown molding structure being removed from a mold.

### DETAILED DESCRIPTION

Implementations of the present disclosure now will be described more fully hereinafter. Indeed, these implementations can be embodied in many different forms and should not be construed as limited to the implementations set forth herein; rather, these implementations are provided so that this disclosure will satisfy applicable legal requirements. As used in the specification, and in the appended claims, the singular forms “a”, “an”, “the”, include plural referents unless the context clearly dictates otherwise. The term “comprising” and variations thereof as used herein is used synonymously with the term “including” and variations thereof and are open, non-limiting terms.

Implementations of the present disclosure provide an environmentally resistant structural member. The structural member includes a core member and a polymer layer. The polymer layer is molded onto the core member on at least one surface, such as around its bottom and/or side surfaces. The polymer layer advantageously protects against water and other environmental elements (e.g., sun, wind, dirt, dust, temperature, etc.) and improves rigidity of the structural member. Also, the structural member advantageously is composed of relatively low cost materials. Further, the structural member can be produced to have the appearance of various wood species.

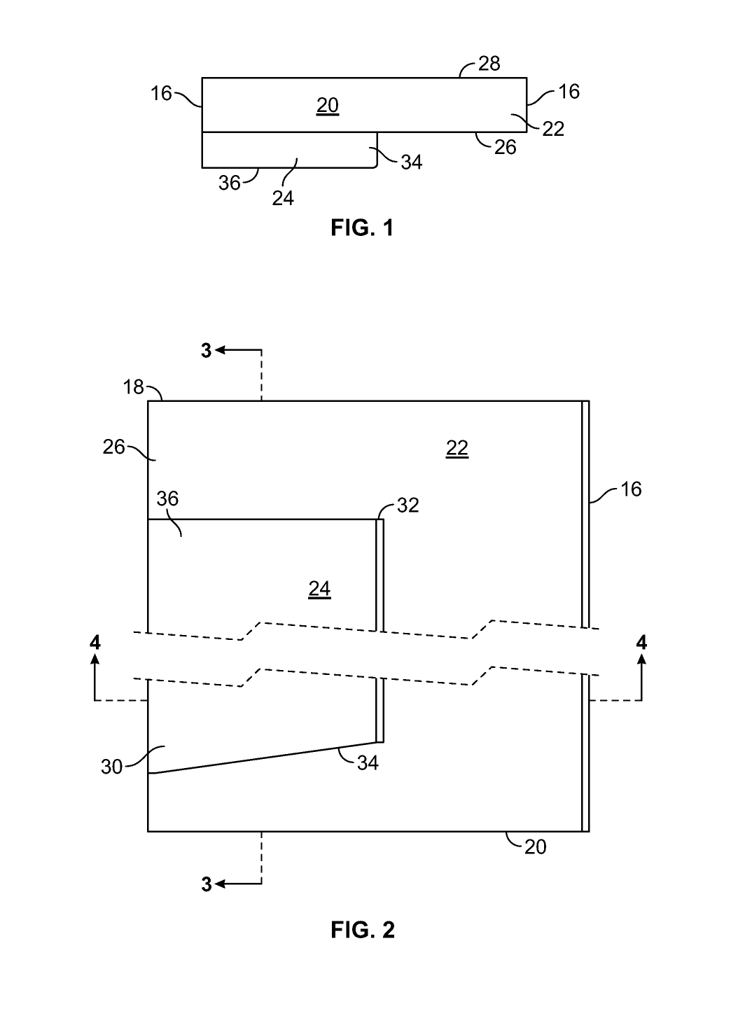

An environmentally resistant structural member in the form of a door jamb 10 is shown in FIGS. 1-5. The door jamb includes a core member 12 and a polymer layer 14, as shown, for example, in FIG. 4. The polymer layer 14 is molded onto the core member 12 at least around its bottom and/or side surfaces. The polymer layer 14 advantageously protects against water and other environmental exposure and improves rigidity of the door jamb 10. Also, the structural member advantageously is composed of relatively low cost materials. Further, the structural member can be produced to have the appearance of various wood species.

Although a door jamb is one implementation and has particular advantages, other implementations of a polymer coated core member are also possible including various structural members for residential and commercial construction. Instead of a door jamb, the structural member may be a cornice, siding, window sashes and frames, garage doors, etc. FIG. 6, for example, shows a polymer coated core member used for crown molding.

The core member 12 may have a water permeable surface. For example, the core member 12 may be a low cost wood substrate, such as pine, which has a fibrous composition (e.g., cellulose) that is prone to wicking up water. Advantageously, the use of the core member 12 can provide structural stability and is less expensive than an entirely polymeric structural member.

The polymer layer 14 may, for example, include or be formed by a polyurethane foam. The polymer layer 14 may be molded to form all of the external surfaces of the door jamb 10. The polymer layer may be molded to have a surface texture, as defined by negative or positive (raised) areas in the mold. For example, the surface texture could be a pebble texture or a wood grain to mimic known and desirable wood types, such as oak, maple, pine or cherry.

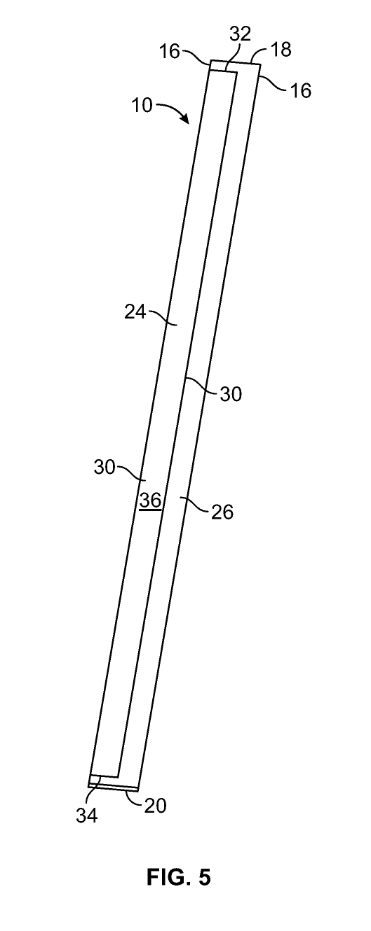

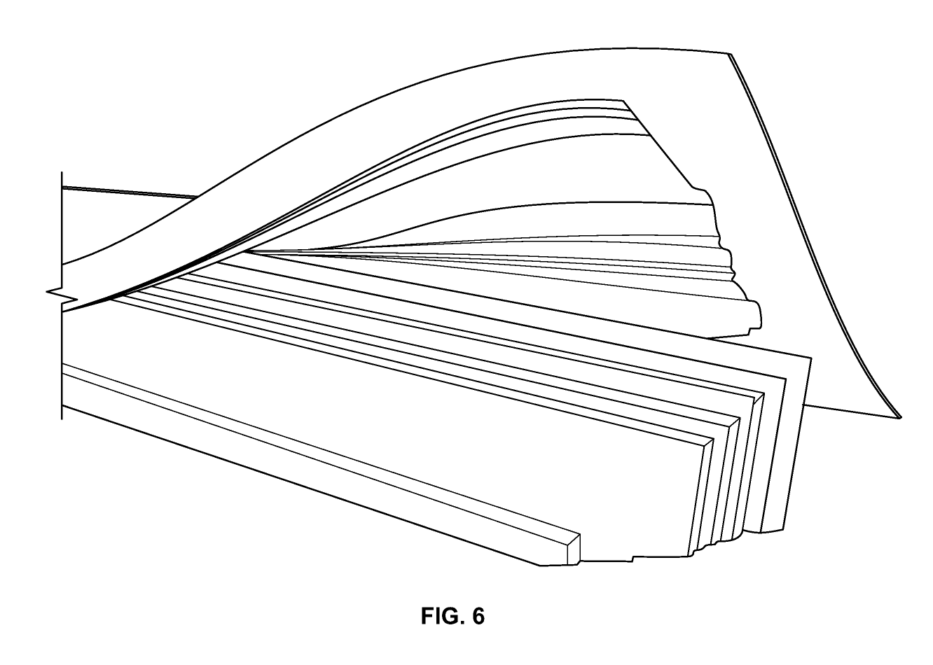

Preferably, the structural member is shaped to be used on an external surface of a structure. For example, as shown in FIG. 5, the door jamb 10 includes a base 22 and a raised portion 24. The base 22 is configured for attachment within or to underlying support structure of an edifice, building, residential home or other structure. The raised portion 24 is configured to abut front surfaces of the door to inhibit swinging of the door in the wrong direction. Both the base 22 and raised portion 24 can work with the door to seal the door opening and prevent intrusion of weather and/or loss of heating and cooling.

The base 22 may include a pair of long sides 16, a top side 18, a bottom side 20, a front surface 26 and a back surface 28. The long sides 16 are generally parallel and the top and bottom sides, 18 and 20, are also generally parallel. Together, the sides form a rectangular shape that can be aligned with and affixed to a standard building structural member, such as a 2×4 frame in a stick-built residential home. The front surface 26 will usually be visible and thus bear some type of a molded finish.

The thickness of the base 22 may be tailored to the size and penetrating capacity of conventional nails and fasteners. For example, the base may be 0.75 inch thick. Other dimensions, such as the length of the various sides can be similarly tailored to the anticipated use. For example, the jamb width (e.g., the length of the top and bottom sides 18, 20) may be 4- 9/16 inches. The length of the long sides 16 may be tailored for standard door heights, such as 7, 7.5 or 8 foot door heights.

Edges of the door jamb 10 may be right-angles or have chamfers, rounds, or other modifications for an attractive appearance or improved function.

The raised portion 24 extends away from the front surface 26 of the base 22 about 0.5 inch, as shown in FIGS. 1, 2 and 5. (It should be noted that the dimensions used herein, although particularly advantageous for particular applications and implementations, should not be interpreted to further limit the claimed invention.) The raised portion 24 includes a pair of long sides 30, a top side 32, a bottom side 34 and a front surface 36. One of the long sides 30 is an extension of the subjacent long side 16 of the base 22, as shown in FIG. 1. The other one of the long sides 30 is a step up from the front surface 26 of the base 22. The stepped up long side 30 and adjacent front surface 36 are configured to abut and seal (or support a seal) against a closed door.

The top edge or side 32 of the raised portion 24 is parallel to, but inset from, the top side 18 of the base 22. This allows the remaining portion of the base 22 to extend under an abutting top doorframe member.

The bottom side 34 of the base 22 is angled slightly with respect to, and inset in from, the bottom side 20 of the base 22. This provides space to accommodate a threshold tread which often has an angled upper surface.

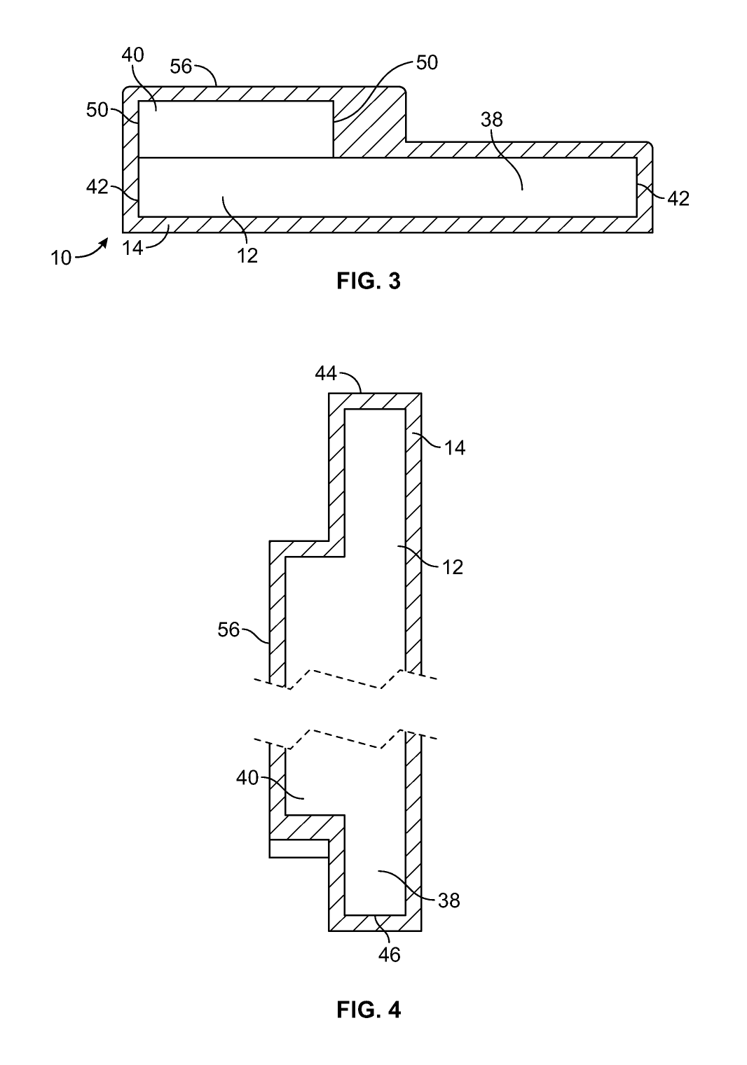

FIG. 3 shows the core member 12 which reflects a nearly congruent shape to the overall door jamb 10. The core member 12 includes a core base 38 supporting a core raised portion 40. The core base 38 may be a distinct wood piece that has a pair of opposing long sides 42, a top side 44 and a bottom side 46, as shown in FIG. 3. The core base 38 has a thickness of about 0.374 inch and a width of about 4.186 inch.

As shown in FIG. 4, the core raised portion 40 also includes a pair of long sides 50, a top side 52, a bottom side 54 and a front surface 56. The core raised portion 40 may be a separate wood (or other fibrous or inexpensive material) piece that is attached to the top surface 44 of the core base 38. The core raised portion 40 for example, may be a 1.561 inch width by 0.188 inch thickness wood piece attached with one of its long sides 50 above and coplanar with the subjacent long side 42 of the core base 38, as shown in the cross-section of FIG. 5. Alternatively, the core base 38 and raised portion 40 may be a unitary piece, such as one milled from a solid, rectangular cross-section.

As shown in FIG. 4, the top and bottom sides 52, 54 of the core raised portion are inset from the top and bottom sides 44, 46 of the core base 38, similar to the outward geometry of the jamb 10. The core raised portion 40 is varied in length to suit the varied length of the core base 38 and the overall door jamb 10 length.

The polymer layer 14, as mentioned above, may be a molded layer that extends around the outer surfaces of the core member 12. Cross-sectional FIGS. 3 and 4 show the enveloping configuration of the polymer layer 14. Generally, the polymer layer 14 may be advantageously 3/16 inch to ⅝ inch thick for external structural member construction to balance rigidity, strength and durability with respect to moisture and other elements. Polyurethanes have the characteristics of being injection moldable and the ability to form a relatively dense coating that lends structural rigidity as well as environmental resistance. Other moldable polymers, however, may also be employed for coating the core member. Thermosetting and thermoplastics may, for example, be employed such as epoxy, phenolic, nylon, polyethylene or polystyrene. Generally, injection molding is capable of tolerances equivalent to an international tolerance grade of about 9-14. The possible tolerance of a thermoplastic or a thermoset may be ±0.008 to ±0.002 inches. Surface finishes of two to four microinches or better can be obtained.

The molding process includes placing the core member 12 in a mould with the final profile of the finished product, such as the door jamb 10. Polyurethane is poured into the mould. The polyurethane may include a two part liquid that foams upon mixing within the mold. Multiple components need not be used and instead a single-component foaming polymer may be used, such as an epoxy that foams when exposed to air.

The mould is shut tight with presses to apply pressure and keep the mould shut tightly while the polyurethane is foaming up. After certain amount of time calibrated to the foam composition, thickness and other parameters, the urethane foam will cure and become harden to the profile of the mould. At this time the press can be released and the mould be opened to pull the part out.

Out of the mould, the part will have the hard, cured polyurethane layer 14 encapsulating the inner wood core member 12. Depending on the density of the polyurethane used, the cured polyurethane around the wood core member 12 can be as soft as cotton or as hard as wood or stone. The density is controlled to meet the requirement of the product application. This final product is protected against the elements of weather, termites, water, salt, etc.

Another advantage of the molding process is the ability to form a predetermined kind of wood profile on the surface. Oak, Cherry, Pine, Maple or Mahogany or any other texture may be formed on the surface because the urethane is initially in liquid form and will expand to fill any detail profile of the mould.

The polyurethane layer 14 can also be primed, stained, cut, shaped, sanded and worked on just like wood. Thus, the door jamb 10 or other structural member can replicate wood but have all the benefit features of maintenance free properties of polyurethane against the elements.

A number of aspects of the systems, devices and methods have been described. Nevertheless, it will be understood that various modifications may be made without departing from the spirit and scope of the disclosure. Accordingly, other aspects are within the scope of the following claims.

### REFERENCE NUMBERS

10 door jamb

12 core member

14 polyurethane layer

16 long sides

18 top side

20 bottom side

22 base

24 raised portion

26 front surface

28 back surface

30 long sides

32 top side

34 bottom side

36 front surface

38 core base

40 core raised portion

42 long sides

44 top side

46 bottom side

50 long sides

52 top side

54 bottom side

56 front surface

1. An environmentally resistant structural member for use in an area exposed to an environmental element, the environmentally resistant structural member comprising:
a core member having an environmentally sensitive composition wherein extended exposure to the environmental element causes degradation of the core member,
the core member including at least one surface wherein the surface is configured for positioning in the area exposed to the environmental element; and
a polymer layer having a molded shape and covering the surface so as to seal the surface of the core member against exposure to the environmental element.

2. An environmentally resistant structural member of claim 1, wherein the at least one surface includes a bottom surface and a side surface.

3. An environmentally resistant structural member of claim 2, wherein the side surface extends adjacent to and around a periphery of the bottom surface.

4. An environmentally resistant structural member of claim 1, wherein the polymer layer is molded about an entire external surface of the core member.

5. An environmentally resistant structural member of claim 1, wherein the polymer layer is a polyurethane.

6. An environmentally resistant structural member of claim 1, wherein the core member has a moisture permeable surface.

7. An environmentally resistant structural member of claim 6, wherein the core member includes a plurality of fibers.

8. An environmentally resistant structural member of claim 7, wherein the fibers are cellulose fibers.

9. An environmentally resistant structural member of claim 8, wherein the core member is a wood member.

10. An environmentally resistant structural member of claim 1, wherein the molded shape has a molded surface texture.

11. An environmentally resistant structural member of claim 10, wherein the molded surface texture has a wood grain pattern.

12. An environmentally resistant structural member of claim 11, wherein the wood grain pattern is one of a group consisting of oak, maple, cherry, pine and mahogany.

13. An environmentally resistant structural member of claim 1, wherein the structural member is configured for external use on a structure.

14. An environmentally resistant structural member of claim 11, wherein the structural member is configured for use as a frame member.

15. An environmentally resistant structural member of claim 1, wherein the polymer layer has a thickness of ⅝ inch or less.

16. A method of molding a structural member, the method comprising:
placing a core member in a mould cavity defining an external shape, the core member having a environmentally sensitive composition wherein extended exposure to an environmental element causes degradation of the core member;
placing at least one polymer component into the mould cavity;
sealing the mould cavity; and
foaming the polymer component to encapsulate at least a portion of the core member and generate an external polymer layer of the structural member that is resistant to the environmental element.

17. A method of claim 16, wherein foaming the polymer component encapsulates the entire core member.

18. A method of claim 16, wherein foaming the polymer component includes combining at least two polyurethane components.

19. A method of claim 16, wherein the core member has a permeable surface and wherein foaming the polymer component includes penetrating the permeable surface of the core member.

20. A method of claim 16, wherein the core member includes a plurality of fibers and wherein foaming the polymer component includes penetrating the fibers of the core member.

21. A method of claim 16, further comprising forming a surface texture on the external layer.

22. A method of claim 16, further comprising sizing the core member to have a gap between edges of the mold and the member of ⅝ inch or less.

23. A method of claim 16, further comprising curing the external polymer layer.
